(19) United States
(12) Patent Application Publication
(10) Pub. No.: US 2010/0264678 A1
(43) Pub. Date: Oct. 21, 2010

(54) Introduction of the panther multi task tool

(76) Inventor: Joseph E. Rolling, JR., Fredonia, NY (US)

Correspondence Address: PATRICIA M. COSTANZO;PATS PENDING, P.O. BOX 101, ELMA, NY, 14059, US

(21) Appl. No.: 12/386,541

(22) Filed: Apr. 20, 2009

(51) Int. Cl. B25B 9/00; B25B 7/00

(52) U.S. Cl. 294/2; 294/106

(57) ABSTRACT

A gripper device, having two rotably connected gripper arms substantially longer than the length of the trigger handle structure, is taught. The arms open when the handle is squeezed and close when handle is released. Each arm has a set of grip and hold hooks. Together, the first grip and hold hook on each arm grips and holds a pair of socks for putting on, while the second grip and hold hook grips and holds socks on a wearer's foot for removal. The device grips and holds up to 25 pounds and grips and lifts up to five pounds. A thumb lock can lock the jam plate into a position relative to the plunger rod providing for unrestricted upward and downward movement of the rod, but when in unlocked position the plunger rod has unrestricted downward, but restricted upward motion allowing for the setting of many width openings.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The principles of the present invention relate generally to a gripper tool and, more particularly, to a gripper tool that provides those with compromised motor skills the ability to grip and maneuver objects they either could not maneuver otherwise or would have a difficult time doing so, for example the tool provides a person who is otherwise unable with the ability to remove or put on his or her own socks. The device, made according to the principles as taught herein, also provides a gripping tool of many uses for all.

The background information discussed below is presented to better illustrate the novelty and usefulness of the present invention. This background information is not admitted prior art.

### SUMMARY

At the heart of the invention is the fact that all gripper tools made according to the principles of the present invention are easy to use even by those of minimal strength as the tool's controlling handle can be set to keep the gripping arms in an open or in a closed position without the user having to maintain a squeezing action on the handle. I, the inventor, realized a need for such a tool when it came to be that I required assistance putting on and taking off my socks. I realized that in my short term disabled state I needed an elongated gripper tool that would enable me to be able to hook onto and hold onto a sock, to be able to manipulate the sock into a position for putting the sock over my foot, and to be able to pull the sock up into a wearable position over my foot, and then to release the sock. Moreover, I wanted a tool that could grab onto the sock that I was wearing to remove it from my foot when I wished to do so. Because at the time, I was in a weakened state, I developed a tool having a controlling handle which requires squeezing only to open the gripping arms of the tool relative to each other. Once the tool is positioned about the object to be gripped, the squeeze on the handle is released and the tool automatically closes to securely hold the object to be released. Moreover, if a user desires to maintain the tool in the open position, there is a locking mechanism on the controlling handle that provides for the gripper arms to be held open without the user having to continuously maintain a squeezing action on the handle. Thus, multi-task gripping tools made according to the principles taught herein were designed and constructed for use by individuals who are motor skill challenged, even those who have the use of only one hand and who ordinarily must depend on others to perform certain tasks, such as putting on or removing their socks or stockings and, because of each tool's unique ability to hook and hold securely onto a great number of items, the tool is useful to the general population as multi-task gripper, as well as providing all individuals with extended reach capability.

The exemplary tool, that will be used illustrated herein, provides the teaching needed to understand how to make and how to use tools using the principles of the present invention. In addition, it will be shown below, how a tool of this invention allows an individual to perform tasks that without the use of the tool would be difficult or impossible for the individual to perform by themselves.

In short, the structure of the device includes a controlling handle structure that is functionally connected to one end of each of a pair of elongated mechanical gripper arms. The other end of each gripper arm is provided with a plurality of hook-like structures required for effective gripping of and holding onto a desired item. Providing for a controlling handle part that is short in length compared to the arms that are many times the length of the handle provides the leverage required for a user to pick up and/or hold heavy, as well as light items. For example, the tool can easily pick up a five pound brick and can securely hold a pair of 25 pound work boots for storage purposes. The rotable connection between the mechanical gripper arms that is provided by the structure of the controlling handle provides for the arms to be opened and closed with respect to one another, that is, for each arm to be displaced away from the other, similar to the action of a pincer pliers in that there is a pair of elongated levers that is this case are the mechanical arms joined at a pivot. Each of the gripping ends of the mechanical arms is fitted with hook and hold extensions so that the device, among other uses, may be used for putting-on or removing socks, and in when used in this manner the hook and hold extensions are referred to as sock heel and toe hook-like extensions. The hook and hold extensions allow for a user, especially a user with compromised bending and reaching ability, to be provided with greatly extended gripping abilities. The design of the device provides for the reaching and grabbing force, even if minimal, to be amplified and focused on the object with precision.

In the embodiment illustrated, the mechanical gripper arms are not connected to each other directly. As illustrated, in order for the gripper arms to be functionally connected to a common pivot point, each of the mechanical arms is fixedly connected to opposing sides of an arm support ring. The arm support ring is made up of two half-rings with each half-ring having two ends. Each of the two mechanical arms is fixedly connected to a half-ring in the area central to the two ends of the half-ring, and each of the ends of each of these half-rings are rotably connected to the opposing ends of the other ring. It is this set of rotable connections that provides for the mechanical gripper arms to be moved apart from and brought back toward each other in response to actuating a trigger mechanism that is part of the structure of the controlling handle. It is to be understood that this arrangement of half rings connected to each other at their respective ends, and having each of the two arms connected to each half ring at a central area between the two ends of each ring, could be, if desired, replaced by other means of connecting the arms to each other. To those of ordinary skill in the art, the rotable connection of each of these arms to the other could be accomplished in a variety of ways. The exact connection would not impact the novelty of the device, as the rotable connection is but one of the mechanical connections that makes the invention and how it works, unique.

The rotatable drive action of the illustrated device is provided by the structure of the control handle that works in a manner somewhat similar to, but different from, a caulking gun handle, as can be seen in the illustration provided below. Basically, the control-handle structure consists of a trigger-like action, i.e., a moveable trigger handle part, a fixed handle part opposing the trigger handle part, a jam plate, a locking mechanism to control the working of the jam plate, a compression spring that is actuated by the motion of the trigger action and a moveable plunger rod that is also actuated by the motion of the trigger mechanism. One end of the plunger rod extends upwardly from the trigger handle part of the control-handle structure through an accepting aperture of the handle part and the other end of the plunger rod extends downwardly from the trigger handle part extending through a and functionally connected to a compression spring that is activated by activation of the trigger mechanism. The moveable trigger handle part and the fixed handle part are rotably connected to each other so that they may be squeezed together and released apart. When the handle parts are squeezed together the compression spring is compressed. The compression spring, as mentioned earlier, is also connected to the plunger rod that extends through and some distance beyond the spring. At some distance from the spring below the trigger handle there is pivotally connected to the end of the plunger rod two spreader arms, with one spreader arm connected to one mechanical gripper arm and the other spreader arm connected to the other mechanical gripper arm. When the trigger handle is squeezed, the spring is compressed and the rod is pushed downwardly between the mechanical arms forcing the spreader arms to extend outwardly away from each other and the rod and, thus, effectively pushing the mechanical arms away from each other. Attached to and between the gripper arms at a short distance below the spreader arm connections to the gripper arms is another compression biasing spring biasing the two arms towards each other. Thus, releasing the trigger handle results in an automatic inward motion of the two mechanical arms when the thumb lock holds the jam plate in the locked positioned (i.e., when the jam plate is locked into a horizontal position relative to the vertical plunger rod providing for unrestricted upward and downward movement of the plunger rod through the aperture of the jam plate). Thus, it is squeeze to open and release to hold, when the device is in the locked position. Release to hold is important for those who have the physical strength to maintain a short squeeze, such as the time it takes to open the mechanical gripping arms and place the gripper parts of the arms about an object to be gripped, but who cannot sustain a squeeze for an extended period of time. If the lock plate is in the unlocked position when the handle is released (i.e., when the jam plate is not locked into a horizontal position relative to the vertical plunger rod, but is allowed to assume an off-horizontal position providing for unrestricted downward movement of the plunger rod through the aperture of the jam plate, but restricting upward motion of the plunger rod through the aperture of the jam plate, as is well-understood by those of ordinary skill in the art), the arms stay in their open position. The handles may be squeezed again to open the mechanical arms further.

Multi-task gripper devices made according to the principles taught herein are offered by providing for a gripper device having two rotably connected gripper arms each substantially longer than the length of an operably attached controlling trigger handle structure, the controlling trigger handle structure having a trigger handle and the gripper arms so arranged as to cause the arms to open when the trigger handle is squeezed and to close when trigger handle is released.

In one preferred embodiment, the ratio of the axial length of the gripper arm to the axial length of the trigger handle is at least four to one, while in another preferred embodiment the ratio of the axial length of the gripper arm to the axial length of the trigger handle is at least six to one.

Furthermore, one end of each gripper arm is functionally attached to the controlling trigger handle and the other end of each gripper arm is fitted with a grip and hold hook device providing for the other end to be a gripping end.

Moreover, the gripping end is fitted with a second grip and hold hook device arranged for gripping and holding socks on a wearer's foot.

Thus made, the gripper device is capable of gripping and holding onto otherwise unsupported objects of up to 25 pounds and is capable of gripping and lifting objects of up to five pounds, as the hook and hold hook devices provide four pressure holding spots for holding a object securely.

The controlling trigger handle structure further comprises a trigger handle having a moveable trigger handle part rotably attached to and opposing a fixed handle part, where the controlling trigger handle structure further includes a compression spring that is operably connected to a plunger rod that extends above and below the compression spring and where the controlling trigger handle structure further comprises an arm spreader mechanism comprising two spreader arms each having one end fixedly connected to one gripper arm and the other end pivotally connected to the end of the plunger rod that is so connected to the trigger handle that when the trigger handle parts are squeezed together the spring is compressed pushing the plunger rod downwardly forcing the spreader arms outward away from an axial line of the plunger rod and thus, effectively pushing the gripper arms away from each other.

Importantly, the controlling trigger handle structure further comprises a thumb lock and a jam plate arranged so that when the thumb lock locks the jam plate, the jam plate is locked into a horizontal position relative to the vertical plunger rod providing for unrestricted upward and downward movement of the plunger rod through the aperture of the jam plate and when the the jam plate is not locked the jam plate is not locked into a horizontal position relative to the vertical plunger rod so maintains an off-horizontal position providing for unrestricted downward movement of the plunger rod through the aperture of the jam plate, but restricting upward motion of the plunger rod through the aperture of the jam plate.

The principles of the present invention may also be described as providing for a multi-task gripper device, comprising:
a gripper device having:
two opposing rotably connected gripper arms
a controlling trigger handle structure providing for opening and closing the gripper arms using a plunger rod actuated by movement of the trigger handles, the plunger rod positioned between the gripper arms,
two spreader arms, one attached to one gripper arm and one attached to the other gripper arm and both rotably attached to the plunger rod arranged so squeezing the trigger handle causes downward movement of the plunger rod that causes movement of the spreader arms away from the plunger rod and thus causes outward movement of the gripper arms,
a biasing spring attached between and to the gripper arms biasing the gripper arms towards each other,
so that squeezing the trigger handle opens the gripper arms for positioning about an object and releasing the trigger handle closes the gripper arms for secure gripping of the object.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention and are not therefore to be considered limiting in scope, thus, the invention will be described and explained with additional specificity and detail through the use of the accompanying drawings, in which:

FIG. 1 is a see-through side elevation view of a gripper tool embodiment according to the principles of the present invention.

FIG. 2 is a partial cross-sectional view with a partial perspective view of the gripper tool, as shown in FIG. 1.

FIG. 3 is an elevation view of the gripper tool, as shown in FIG. 1, holding a sock about to be put on a person's foot.

FIG. 4 is an elevation view of the gripper tool, as shown in FIG. 1, holding a sock about to be removed from a person's foot.

FIG. 5 is an elevation view of the gripper tool, as shown in FIG. 1, holding a sock that has just been removed from a person's foot.

FIG. 6 is an elevation view of the gripper tool, as shown in FIG. 1, gripping onto a glass containing a liquid.

FIG. 7 is an elevation view of the gripper tool, as shown in FIG. 1, gripping onto a pair of workmen's boots so that they may be stored by hanging from a closet rod.

FIG. 8a is an elevation view of the gripper tool, as shown in FIG. 1, gripping onto a fragile article, such as a light bulb.

FIG. 8b is an elevation view of the gripper tool, as shown in FIG. 1, gripping onto a cloth for dusting an object in a difficult to reach position.

FIG. 8c is an elevation view of the gripper tool, as shown in FIG. 1, with the addition of a fan blade dusting attachment dusting a fan blade.

FIG. 8d is an elevation view of the gripper tool, as shown in FIG. 1, with the addition of a gutter cleaning attachment cleaning a gutter.

### A LIST OF REFERENCE CHARACTERS AND PARTS TO WHICH THEY REFER

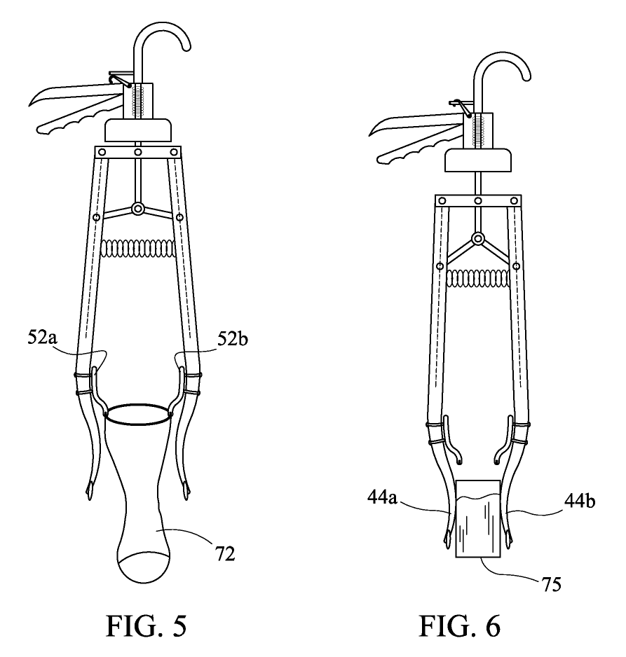

2 Thumb stopper lock in unlocked positioned.
4 Thumb stopper lock in locked position.
5 Jam plate.
6a Bar to add strength to arm 42a.
6b Bar to add strength to arm 42b. (see Page 1, part named FIG. 5)
8a Attachment device for attaching gripping arms to rings.
8b Attachment device for attaching gripping arms to rings.
8c Attachment device for attaching gripping arms to rings.
10 Multi-task gripper device.
12 Arm support/connector ring with opposing pivotable ring connections.
14 One of the opposing pivotable connections of 12.
16 Biasing spring biasing gripper arms 42a and 42b towards each other.
18 Hanging loop.
20 Rotable drive mechanism with spring.
22 Curved end of plunger rod 20 for grasping onto or for hanging use.
23 Hanging rod.
24a Stationary trigger handle.
24b Actionable trigger handle.
26 Compression spring of drive mechanism 20.
28 Plunger rod.
30 Spreader.
32a One spreader arm.
32b Second spreader arm.
34 Pivotable spreader arm connector.
36a Attachment attaching spreader arm 32a to gripper arm 42a.
36b Attachment attaching spreader arm 32b to gripper arm 42b.
40 Arms section.
42a One gripper arm.
42b Second gripper arm.
44a Angled part of arm 42a.
44b Angled part of arm 42b.
45a Grip and hold.
45b Grip and hold.
45c Grip and hold.
45d Grip and hold.
46a Rubber padding.
46b Rubber padding.
50 Gripping end.
52a Sock removal hook and hold.
52b Second sock removal hook and hold.
70 A person's leg with foot attached.
72 Sock.
75 A glass of water.
76 A light bulb.
78 A rag or sponge.
80 A fan blade cleaner attachment.
82 A fan blade.
85 A pair of work boots.
90 A gutter cleaning attachment.
92 A gutter section.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms. Therefore, the embodiments described herein are provided with the understanding that the present disclosure is intended as illustrative and is not intended to limit the invention to the embodiments described herein.

The present invention is directed towards a multi-task tool to make it possible for individuals who ordinarily must depend on others to perform certain tasks such as putting on or removing their socks or lifting or grabbing items that are beyond their reach to do so without asking another for assistance. In short, the device acts like a mechanical arm with grabbing fingers that does not require squeezing of the handle to hold in either an open or a closed position, making it easy for persons of all strengths to use.

Referring now, with more particularity, to the drawings, it should be noted that the disclosed invention is disposed to embodiments in various sizes, shapes, and forms. Therefore, the embodiments described herein are provided with the understanding that the present disclosure is intended as illustrative and is not intended to limit the invention to the embodiments described herein. For example, the mechanical gripper arms in the illustrations are shown being made according to a specific design, however many designs could be implemented. The arms shown in the figures have been shaped as they are simply for aesthetic purposes. Accordingly, the bottom end of the arm has what looks like a foot with a grab and hold contrivance protruding from each side of the “foot”. The “foot” could be just as well be shaped in any other way that will present the grab and holds for effectively supporting a sock to be put onto a user's foot. Moreover, in the illustrations, the gripper arms are indirectly attached to the control handle mechanism by a ring made up of two half rings rotably attached to each other. This design is contemplated to be replaced by mechanical gripper arms that are directly rotably attached to each other.

The present invention is directed towards a multi-task tool. The tool is structured to perform several tasks, which will be discussed below. In short, the device acts like a mechanical arm with grab and hold fingers. All gripping tools made according to the principles as taught herein are light-weight, can be used single handedly, enable compromised individuals to put on and take off their socks, and to reach objects that would otherwise be impossible or difficult to reach, act as a multi-task tool to lift up to at least five pounds and to hold up to 25 pounds, have gripping arms that can be opened to a width of at least about 12 inches between the gripping arms given the length of the arms of the embodiment illustrated (it will be understood by those of ordinary skill in the art that the extent that the arms can open will be increased or decreased depending on the length of the arms), used to lift both very small to quite large sturdy or delicate objects, locked into a desired spacing of the gripping arms, and when the device is in its locked state to provide for each squeeze of the trigger to spread the arms a distance “d” and for that position to be held when the trigger is released, so that with each additional squeeze the arms may be spread apart another distance “d” until a desired spacing is achieved. When the tool is in the unlocked state, squeezing the trigger will spread the arms apart to a distance “d” and releasing the trigger will cause the arms to return to their original position, thus squeeze only to open and release to close or to maintain in a desired open state. The device provides for two elongate mechanical gripper “arms” each rotably functionally connected to the other. In the device illustrated, the rotable (pivotable) connection connecting the two gripper arms is provided by a connection ring (also referred to as “support ring”) to which is fixedly attached one end of each of the two gripper arms. The other ends of the arms are provided with the grab and hold structures required for effective grabbing and holding a desired item, thus these parts of the mechanical arms may be referred to as the gripping, gripper, or grab and hold ends of the arms. The rotable connection between the mechanical arms provides for the arms to be opened and closed with respect to one another, that is, for each arm to be displaced away from the other, similar to the action of a pincer pliers in that there is a pair of elongated levers that is this case are the mechanical arms joined at a pivot. Each of the gripping ends of the mechanical arms is fitted with hook and hold extensions. This arrangement allows for a user, especially a user with compromised bending and reaching ability, to be provided with greatly extended gripping abilities. The design of the device provides for the reaching and grabbing force, even if minimal, to be amplified and focused on the object with precision.

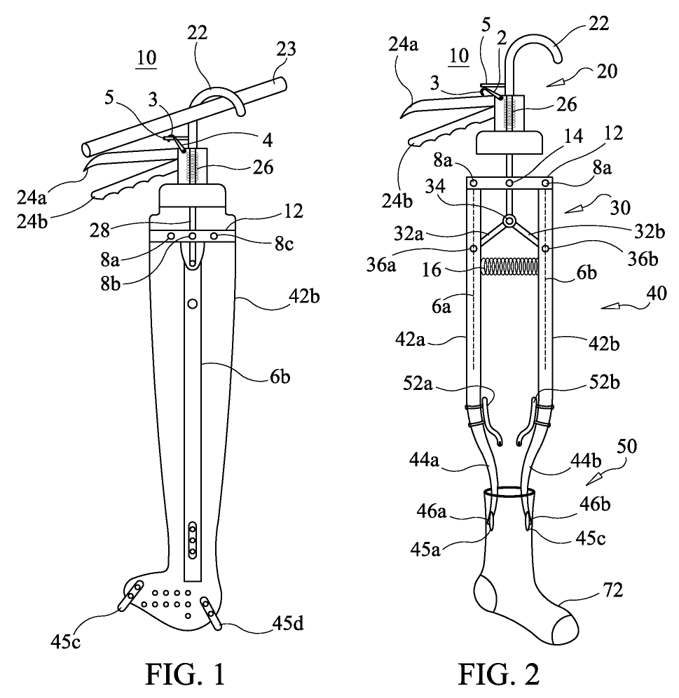

Turning now to the drawings, FIGS. 1 and 2, a see-through side view and a partial cross-sectional front view, respectively, illustrate multi-task gripper device 10 made according to the principles of the present invention. In the embodiment illustrated, there are two mechanical gripper arms 42a and 42b. In the event gripper arms, 42a and 42b are desired to be made stronger, the arms may be strengthened by the addition of a strengthener, such as the strengthening bars indicated by dotted lines 6a and 6b in FIG. 2. In this illustrative embodiment, each of the mechanical gripper arms is fixedly connected (see attachments 8a, 8b, and 8c) to opposing sides of connecting ring 12. Connecting ring 12, in this embodiment, consists of two half-rings. The ends of each half ring are rotably connected to the opposing ends of the other ring (see rotable connection 14 in FIG. 2). Each of the two mechanical gripper arms, 42a and 42b, is fixedly attached to one of the half-rings in the area between the two ends of each ring. It is this set of rotable connections that provides for the mechanical gripper arms to be moved apart and brought back toward each other.

Rotatable drive action for the device is provided by rotable drive action mechanism 20 (also referred as part of the structure of the control handle) that works in a manner somewhat similarly, but differently, to a caulking gun handle. Basically, the handle has a trigger-like action, i.e., the handle contains moveable trigger handle part 24b and fixed handle part 24a opposing the trigger handle part. The two handle parts are rotably connected to each other so that they may be squeezed together and released apart. The drive action also includes compression spring 26 that is wound about and connected to plunger rod 28 that extends some distance above and beyond compression spring 26 to form part of arm spreader mechanism 30 and is so connected to the action of the trigger handle that when the handle parts are squeezed together, the spring is compressed pushing the plunger rod down. Pivotally connected to the end of plunger rod that extends from spring 26 are two spreader arms 32a and 32b, with spreader arm 32a connected to mechanical gripper arm 42a and spreader arm 32b connected to mechanical gripper arm 42b. In short, when trigger handle part 24b is squeezed toward trigger handle part 24a, compression spring 26 is compressed and plunger rod 28 is pushed downwardly toward pivot action 34 that is between and pivotably connects spreader arms 32a and 32b. The opposing ends of spreader arms 32a and 32b are attached to mechanical gripper arms 42a and 42b at attachment points 36a and 36b. When plunger rod 28, by action of the trigger handles, is pushed downwardly toward pivot action 34, the force of the action exerted on pivot action 34 results in forcing spreader arms 32a and 32b outward away from the axial line of plunger rod 28 and, thus, effectively pushes mechanical arms away from each other about pivot point 14. It is clear from the drawings that the gripper arms are substantially longer than the control handle. This is required by the illustrated uses of the device. So that the device may be useful for a tall person who requires use of the device to put on or take off his socks, the ratio of the axial length of the gripper arms to the axial length of the handle would have to be at least six to one. Alternatively, if the device were to be made for use by children or very short people the ratio could be less, say about 3:1 or 4:1. The ratio is important when the device is to be used for gripping objects positioned at a distance, for lifting heavier objects, or for changing light bulbs or cleaning the gutters, as illustrated in the drawings.

The device may be operated in either a locked state, when thumb lock 3 is in locked position 4, to lock jam plate 5 in a horizontal position relative to the vertical plunger rod freeing the motion of the rod in both an upward and downward direction or when thumb lock 3 is in the locked position 2 freeing jam plate 5 from a horizontal position allowing the rod to move downward, but not upward (or backwards). If the thumb lock 3 is in its locked positioned, each squeeze of the trigger spreads the arms a distance “d” and holds that position when the trigger is released, allowing a user to open the arms further, if desired. Each additional squeeze, when the device is in the locked position, spreads the arms apart another distance “d” until a desired spacing is achieved. When the tool is in the unlocked state, squeezing the trigger will spread the arms apart to a distance “d” and releasing the trigger will cause the arms to close.

In addition to mechanical gripper arms 42a and 42b, arms section 40 includes two different sets of grip mechanisms. One set includes sock removal hook 52a and opposing sock removal hook 52b located adjacent to angled parts 44a and 44b of mechanical gripper arms 42a and 42b, respectively. The function of these removal hooks is discussed below. The other set of grip mechanisms includes grip and holds 45a and 45c that extend from the gripping end 50 of mechanical gripper arms 42a and 42b, respectively. In this example, all of the grip mechanisms are coated with a layer of rubber or other material with similar cushioning effect (see 46a and 46b), to provide both a cushioning effect and a greater frictional hold on the item to be gripped and held. Between mechanical gripper arms 42a and 42b and relatively adjacent to the points where spreader arms 32a and 32b are attached to arms 42a and 42b, biasing spring 16 is attached to and between arms 42a and 42b. The compressive force of biasing spring 16 bias the two gripper arms towards each other resulting in a user being able to release, not squeeze, the trigger handle in order to maintain a gripping hold on an object. The present tool maintains a sufficient squeeze on a gripped object because of the compressive, biasing force of biasing spring 16 and thus, can be relied upon to pick up and maintain a secure hold on a heavier object than can other grippers.

It should be noted that the invention, as taught, has mechanical gripper arms that are substantially longer than the length of the trigger handle mechanism. The substantially greater length of arms to length of handle ratio of the gripper arms of the present invention provides for a much greater potential opening of the gripper arm, which, in turn, provides for the gripping and lifting of much larger sized objects. For example, the present invention could easily pick up an object that is about a foot in diameter. For example, the device is able to pick up items weighing about 5 pounds (such as a brick), and can hold onto items up to 25 pounds (such as a pair of workman's boots). The gripper made according to the presently taught principles has at least four points of holding pressure when squeezing an object. Persons of ordinary skill in the art readily appreciate that if the gripper had only 2 pressure lifting points, it could pick up a sponge or drinking glass filled with water but could not hold such objects in a stable state. And, importantly, the current invention provides a compromised individual with the ability to put on and take off his or her own socks.

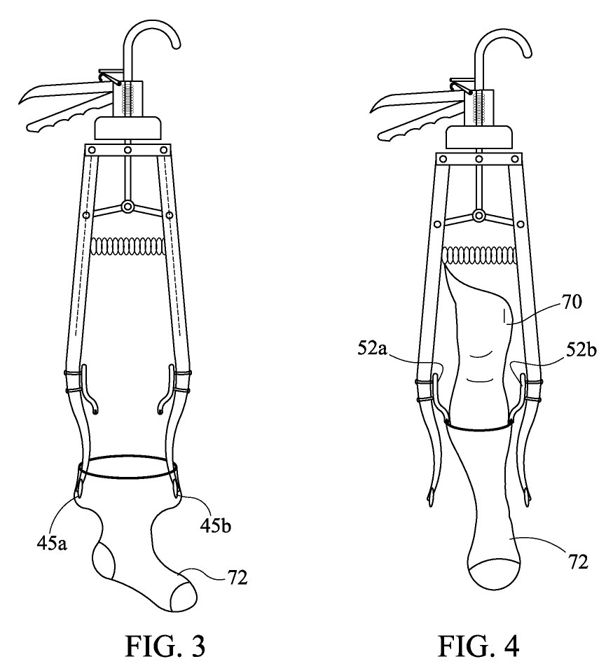

FIG. 3, a partial cross-sectional front view, further illustrates the gripper device of the present invention with its mechanical gripper arms extended so that grip and holds 45a and 45b are positioned to hold a leg of sock 72 in the open position required to accept a user's foot. Once a user's foot is in the sock, a gentle tug on the device pulls the sock fully into its proper position over a user's foot. Note that the device is in the locked position so that the arms may be opened to the spacing desired between the arms and so that the arms will remain in the desired spacing until the sock is in position, at which time the lock may be unlocked so that the arms will close to release the sock.

FIG. 4, a front view, illustrates the gripper device made according to the principles of the present invention positioned for removal of a sock from a foot. When a user wishes to remove his or her socks, the device is open to the extent the arms will fit about a user's leg and then the tool is positioned about a user's leg 70 so that grab and holds 52a and 52b can be slipped into the sock's 72 opening that is positioned about the user's leg. If required, the tool that up until this point is in the locked mode could be unlocked so that the tool fits more snugly about the user's leg. At this point, all the user has to do is to push the device further toward his foot and the tool will push the sock off of his foot. The tool handle, in the unlocked mode, could then be squeezed (using only one hand if necessary) to open the tool sufficiently to lift the sock and deposit it in a proper receptacle. FIG. 5 illustrates how the mechanical gripper arms and the grab and holds 52a and 52b maintain the sock in a stretched opening position until after the user's foot is removed from the sock.

FIG. 6 illustrates grip and holds 45a and 45b are positioned to hold and lift delicate water glass 75 without breaking the glass or spilling the water.

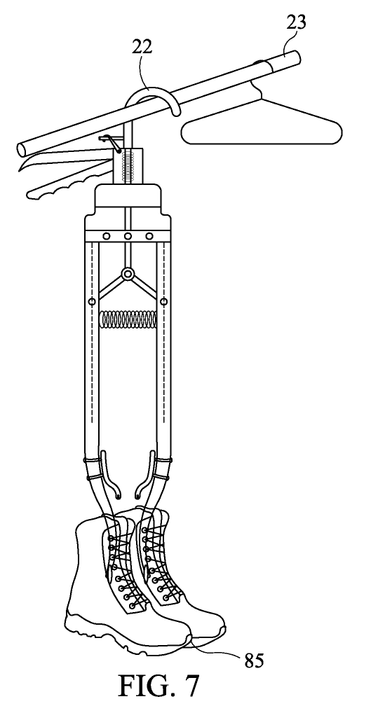

FIG. 7 illustrates the device being used to hang work boots 85 on closet rod 23 for storage. Here, curved handle part 22 is the means used to hang the device from the rod.

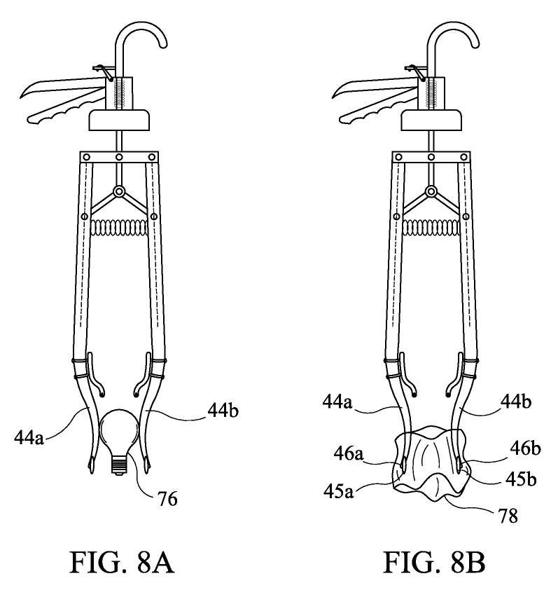

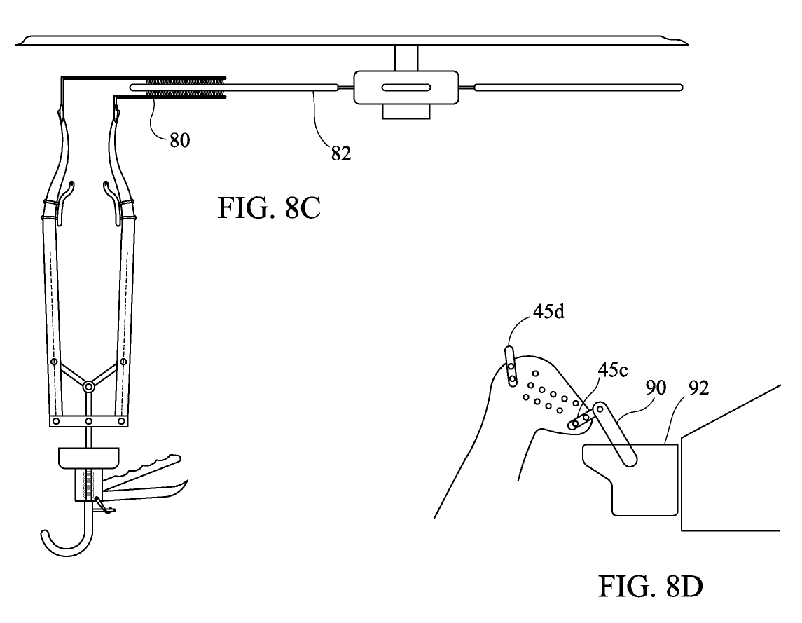

FIG. 8a illustrates the angled parts 44a and 44b of the gripper arms device used to securely hold light bulb 76 for insertion (or removal) from a difficult to reach light-bulb socket.

FIG. 8b illustrates the device being used to hold towel 78, which could also be sponge, or cloth, for dusting difficult to reach places. FIG. 8c illustrates the device being used with its fan dusting blade accessory 80 to clean both sides of the blades 82 of a ceiling fan. FIG. 8d illustrates the grab and hold 45c being used to support gutter cleaning tool accessory 90 to clean gutter 92.

The foregoing description, for purposes of explanation, uses specific and defined nomenclature to provide a thorough understanding of the invention. However, it will be apparent to one skilled in the art that the specific details are not required in order to practice the invention. Thus, the foregoing description of the specific embodiment is presented for purposes of illustration and description and is not intended to be exhaustive or to limit the invention to the precise form disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1-12. (canceled)

12. A multi-task gripper device, comprising:
a gripper device having two rotably connected gripper arms each substantially longer than the length of an operably attached controlling trigger handle structure, said controlling trigger handle structure having a trigger handle and said gripper arms so arranged as to cause said arms to open when said trigger handle is squeezed and to close when trigger handle is released.

13. The multi-task gripper device, as recited in claim 1, wherein the ratio of the axial length of said gripper arm to the axial length of said trigger handle is at least four to one.

14. The multi-task gripper device, as recited in claim 1, wherein the ratio of the axial length of said gripper arm to the axial length of said trigger handle is at least six to one.

15. The multi-task gripper device, as recited in claim 1, wherein one end of each gripper arm is functionally attached to said controlling trigger handle and the other end of each gripper arm is fitted with a grip and hold hook device providing for said other end to be a gripping end.

16. The multi-task gripper device, as recited in claim 4, wherein said gripping end is fitted with a second grip and hold hook device arranged for gripping and holding socks on a wearer's foot.

17. The multi-task gripper device, as recited in claim 4, wherein said gripper device is capable of gripping and holding onto otherwise unsupported objects of up to 25 pounds.

18. The multi-task gripper device, as recited in claim 1, wherein said gripper device is capable of gripping and lifting objects of up to five pounds.

19. The multi-task gripper device, as recited in claim 5, wherein said hook and hold hook devices provides four pressure holding spots for holding an object securely.

20. The multi-task gripper device, as recited in claim 5, wherein said controlling trigger handle structure further comprises a trigger handle having a moveable trigger handle part rotably attached to and opposing a fixed handle part.

21. The multi-task gripper device, as recited in claim 9, wherein said controlling trigger handle structure further includes a compression spring that is operably connected to a plunger rod that extends above and below said compression spring.

22. The multi-task gripper device, as recited in claim 10, wherein said controlling trigger handle structure further comprises an arm spreader mechanism comprising two spreader arms each having one end fixedly connected to one gripper arm and the other end pivotally connected to the end of said plunger rod that is so connected to the said trigger handle that when the trigger handle parts are squeezed together the spring is compressed pushing the plunger rod downwardly forcing said spreader arms outward away from an axial line of said plunger rod and thus, effectively pushing said gripper arms away from each other.

23. The multi-task gripper device, as recited in claim 11, wherein said controlling trigger handle structure further comprises a thumb lock and a jam plate arranged so that when said thumb lock locks said jam plate, said jam plate is locked into a horizontal position relative to the vertical plunger rod providing for unrestricted upward and downward movement of the plunger rod through the aperture of the jam plate and when the said jam plate is not locked the jam plate is not locked into a horizontal position relative to the vertical plunger rod so maintains an off-horizontal position providing for unrestricted downward movement of the plunger rod through the aperture of the jam plate, but restricting upward motion of the plunger rod through the aperture of the jam plate,

24. A multi-task gripper device, comprising:
a gripper device having:
two opposing rotably connected gripper arms
a controlling trigger handle structure providing for opening and closing said gripper arms using a plunger rod actuated by movement of the trigger handles, said plunger rod positioned between said gripper arms,
two spreader arms, one attached to one gripper arm and one attached to the other gripper arm and both rotably attached to said plunger rod arranged so squeezing said trigger handle causes downward movement of said plunger rod that causes movement of said spreader arms away from said plunger rod and thus causes outward movement of said gripper arms,
a biasing spring attached between and to said gripper arms biasing said gripper arms towards each other,
so that squeezing said trigger handle opens said gripper arms for positioning about an object and releasing said trigger handle closes said gripper arms for secure gripping of the object.

25. The multi-task gripper device, as recited in claim 13, wherein the ratio of the axial length of said gripper arm to the axial length of said trigger handle is at least four to one.

26. The multi-task gripper device, as recited in claim 13, wherein said ratio of the axial length of said gripper arm to the axial length of said trigger handle is at least six to one.

27. The multi-task gripper device, as recited in claim 13, wherein said trigger handle further comprises a moveable trigger handle part rotably connected to an opposing fixed handle part.

28. The multi-task gripper device, as recited in claim 16, further comprising a compression spring connected to said trigger handle so that when said moveable trigger handle part and said opposing fixed handle part are squeezed together the spring is compressed.

29. The multi-task gripper device, as recited in claim 17, wherein said compression spring is wound about and connected to said plunger rod so that when the handle parts are squeezed together, the compressed spring forces said plunger rod to move downward.

30. The multi-task gripper device, as recited in claim 18, wherein said controlling trigger handle structure further comprises a thumb lock and a jam plate arranged so that when said thumb lock locks said jam plate, said jam plate is locked into a horizontal position relative to the vertical plunger rod providing for unrestricted upward and downward movement of the plunger rod through the aperture of the jam plate.

31. The multi-task gripper device, as recited in claim 19, wherein said controlling trigger handle structure further comprises a thumb lock and a jam plate arranged so that when said thumb lock is not locking the jam plate in a horizontal position relative to the vertical plunger rod, said jam plate maintains an off-horizontal position providing for unrestricted downward movement of the plunger rod through the aperture of the jam plate, but restricting upward motion of the plunger rod through the aperture of the jam plate.
